(19) United States
(12) Patent Application Publication
(10) Pub. No.: US 2026/0245997 A1
(43) Pub. Date: Aug. 20, 2026

(54) Autonomous Mobile Robots and Vehicles Adapted for Sterile Environments

(71) Applicant: OMRON Corporation, Kyoto-shi (JP)

(72) Inventors: Sean Bailey, Emeryville, CA (US); Matt Vestal, Keene, NH (US); Seth Dunten, Castro Valley, CA (US)

(73) Assignee: OMRON Corporation, Kyoto-shi (JP)

(21) Appl. No.: 19/539,256

(22) Filed: Feb. 13, 2026

Related U.S. Application Data
(60) Provisional application No. 63/759,455, filed on Feb. 17, 2025.

(51) Int. Cl. H01M 10/46; H02J 7/00

(52) U.S. Cl. CPC H01M 10/46; H02J 7/00

(57) ABSTRACT

The various implementations described herein are directed to autonomous mobile robots or vehicles that are adapted for sterile environments. In one aspect, an autonomous mobile robot (AMR) includes a set of functional components enclosed in a sealed housing. The AMR includes a set of sensors configured to monitor a vicinity of the AMR. The AMR includes a compliant linkage configured to connect the sealed housing to a topper cart with relative movement between the sealed housing and the topper cart in two degrees of freedom. The AMR further includes a set of drive wheels coupled to the sealed housing and configured to enable movement of the AMR.

### RELATED APPLICATIONS

This application claims priority to U.S. Provisional Patent Application No. 63/759,455, entitled “Autonomous Mobile Robots and Vehicles Adapted for Sterile Environments,” filed Feb. 17, 2025, which is hereby incorporated by reference in its entirety.

### TECHNICAL FIELD

The disclosed embodiments relate generally to autonomous machine technology, and more specifically to autonomous mobile robots (AMRs) and vehicles that are adapted for sterile environments.

### BACKGROUND

AMRs can be used to transport payloads, sensors, and other components for industrial applications, and are particularly useful for companies seeking to harness a flexible manufacturing paradigm. Many conventional AMRs are designed to be general-purpose robots that operate in non-sterile environments. These AMRs are not suited for certain tasks and environments such as certain medical device tasks, pharmaceutical tasks, bioprocessing tasks, semiconductor processing tasks, and/or food processing tasks, which require sterile and/or cleanroom environments. Furthermore, devices that operate in sterile and/or cleanroom environments need to undergo cleaning validation to establish that they can be effectively cleaned (e.g., have high cleanability) and have the ability to stay clean (e.g., not collecting particles and not generating particles (e.g., non-biological and biological particles)) to maintain the sterility and cleanliness of these environments. Conventional AMRs are composed of materials and/or have designs and architectures that cannot meet these requirements.

### SUMMARY

As mentioned above, conventional AMRs (e.g., general-purpose AMRs) having materials that are difficult to sterilize as well as crevices, seams, and/or gaps are ill-equipped to be used in applications that require sterile and/or cleanroom environments (e.g., pharmaceuticals and bioprocessing applications) because they do not meet the cleanability requirements to operate in these environments. Cleanability requirements generally refer to the materials used in a device, the physical configuration of the device, and the resulting ability of a trained technician to thoroughly clean the device, such that particles are not generated or accumulated and then released into the sterile and/or cleanroom environment. For example, for pharmaceutical applications, particles of particular interest are those of biological origin, such as bacteria and spores. Conventional AMRs are made using materials that cannot withstand the cleaning chemicals (e.g., isopropanol (IPA) or hydrogen peroxide) or cleaning processes that are used to maintain device cleanliness in these environments. As another example, current AMR designs have gaps or cracks between mating surfaces, or crevices or uneven surfaces, which lead into large interior volumes that are difficult if not impossible to effectively clean. These gaps, cracks, and/or interior volumes allow for the entry, propagation, and distribution of undesirable biological agents, which cannot be effectively mitigated by cleaning. As an example, there is a desire that devices used in a sterile or cleanroom environment should perform their intended functions and have designs as close to a “pharma egg” as is practical, such as having a smooth, egg-shaped design with no seams and made entirely out of cleaning-compatible materials such as stainless steel, silicone, and/or certain plastics that have a smooth texture and are resistant to cleaning chemicals.

While some sterile/cleanroom environments use industrial robot arms, making a sterile/cleanroom-compatible AMR is technically more difficult and challenging than implementing stationary robot arms at locations within the environments. Specifically, due to the mobile nature of AMRs, AMRs have wheels that are in constant contact with the floor (e.g., which is likely the dirtiest space in the cleanroom), meaning that they are more susceptible to getting dirty and more likely to transport particles and dirt through the environment. Moreover, AMR functional payloads (e.g., topper components) are highly varied in size, shape, weight, and power requirements and need to be considered as an integral part of the system. Furthermore, the mobile nature of AMRs means that there is no mounting plate to route cables through to “outside” the controlled environment as could be done with stationarily-mounted components such as robot arms.

Accordingly, there is a need for AMRs and other autonomous devices that are adapted for sterile and/or cleanroom environments, to fulfill the needs for industries that operate in such environments. The present disclosure describes, amongst other things, AMRs and vehicles that are adapted for (e.g., designed, built, and configured for) operating in these types of environments.

In accordance with some embodiments, an autonomous mobile robot (AMR) or other type of autonomous vehicle includes: (1) a set of functional components enclosed in a sealed housing; (2) a set of sensors configured to monitor a vicinity of the AMR; (3) a compliant linkage configured to connect the sealed housing to a topper cart with relative movement between the sealed housing and the topper cart in two degrees of freedom; and (4) a set of drive wheels coupled to the sealed housing and configured to enable movement of the AMR. For example, the sealed housing may promote cleanliness (thereby improving health and safety) by being composed of a material that is cleanroom compliant, such as by being smooth (e.g., to trap less dirt and debris) and cleanable by cleaning processes (e.g., using isopropanol and/or hydrogen peroxide). The sealed housing may also promote cleanliness by having fewer seams, crevices, gaps, and other geometries that would be difficult to clean (e.g., by hand or using a vaporized cleaning process). The compliant linkage allows the drive wheels to remain in contact with a rough or uneven surface even in the presence of non-drive wheels on the topper cart, which improves the mobility of the AMR.

In accordance with some embodiments, an AMR includes one or more processors (e.g., a processing component) and memory. In some embodiments, the AMR includes a drive component (e.g., a gear box). In some embodiments, the AMR includes an energy storage component and a charging component. The memory stores instructions that, when executed by the one or more processors, cause the AMR to perform any of the operations disclosed herein.

In accordance with some embodiments, a non-transitory computer-readable storage medium stores one or more programs configured for execution by an AMR having one or more processors and memory. The one or more programs include instructions for performing any of the operations disclosed herein.

Thus, apparatuses, devices, and systems are disclosed for autonomous operations. Such apparatuses, devices, and systems may complement or replace conventional means of autonomous operation. The systems, devices, and interfaces of this disclosure each have several innovative aspects, no single one of which is solely responsible for the desirable attributes disclosed herein.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and therefore are not necessarily to be considered limiting, for the description can admit to other effective features as the person of skill in the art will appreciate upon reading this disclosure.

FIGS. 1A, 1B, 1C, and 1D illustrate example views of an AMR that is adapted to operate in a sterile environment, in accordance with some embodiments.

FIG. 2 illustrates an example sensor configuration on AMR, in accordance with some embodiments.

FIG. 3 illustrates an example AMR that includes a robot manipulator topper, in accordance with some embodiments.

FIG. 4 is a block diagram of an example AMR, in accordance with some embodiments.

In accordance with common practice, the various features illustrated in the drawings are not necessarily drawn to scale, and like reference numerals can be used to denote like features throughout the specification and figures.

### DETAILED DESCRIPTION OF IMPLEMENTATIONS

The present disclosure describes AMRs and vehicles that are adapted for use in sterile and/or cleanroom environments. The disclosed AMRs may include an “inside-out” architecture where at least a subset of functional components of the AMR are enclosed in a sealed housing. The disclosed AMRs may include a compliant linkage configured to connect the sealed housing to a topper cart, to allow the drive wheels of the AMR to maintain control while accommodating driving surface irregularities. The geometry and configuration of the topper carts may be adapted to support specific toppers or payloads. The topper cart may include non-drive wheels that are located at specific positions of the topper cart to promote stability. The AMR may include a toe guard that protects a person's feet from injury while allowing for an open and easily cleanable structure. In some embodiments, the AMR is battery-operated. In some embodiments, the battery is configured to be charged via inductive charging. In some embodiments, the inductive charging pad is elevated off the floor and the mating charge received on the AMR is elevated for enhanced access to the underside of the AMR, e.g., for high cleanability. In some embodiments, the AMR is physically configured to facilitate cleanability. In some embodiments, components of the AMR that are exposed are made of materials that facilitate cleanability. In some embodiments, the AMR meets Good Manufacturing Practices (GMP) guidelines imposed by certain industries such as the pharmaceutical industry (e.g., indicating that the disclosed AMR can be cleaned and has the ability to stay clean). Although the descriptions herein refer to AMRs, the aspects described with respect to the AMRs can also be applied to other autonomous equipment, such as tuggers, power lifts, and autonomous forklifts.

In various embodiments of this application, methods, systems, and devices are disclosed that support the adaption of AMRs for use in sterile environments. In accordance with some embodiments, an AMR includes a sealed functional device (also sometimes called a “core”) in which a set of one or more functional components are enclosed (e.g., encapsulated) in a sealed housing. The sealed housing may be designed (e.g., configured) with open and easily accessed surfaces (e.g., to facilitate cleanliness and cleanability of the AMR). In some embodiments, the AMR includes a set of driving wheels that are positioned at an exterior of the sealed housing. In some embodiments, the AMR includes sensors mounted on either side (e.g., left side and right side) or either end (e.g., front end and back end) of the AMR, e.g., for safety and navigation.

In some embodiments, the AMR includes a topper cart that is designed to facilitate high cleanability. In some embodiments, the AMR is configured to connect with (and operate with) topper carts created by a third party (e.g., in accordance with a set of specifications for the AMR). For example, the AMR is configured to connect with topper carts via a linkage component. In some embodiments, the topper cart includes a single, center-located vertical beam on either side (e.g., left side and right side) or either end (e.g., front end and back end) of the AMR. Advantageously, the simple beam design supports cleanability, supports a topper component (sometimes referred to simply as a topper), and also allows the sensors to have a 360-degree field of view of the surroundings of the AMR.

In some embodiments, the topper cart supports a topper. In some embodiments, the topper cart is “topper-specific,” in that the topper cart is adapted/configured to support a particular type of topper. In some embodiments, the topper cart is configured to support multiple types of toppers. Example topper types include a roll top topper, a deck load platform, a mobile manipulator, or and other types of toppers designed for a particular purpose and/or function. In some embodiments, the topper cart includes a set of caster wheels (e.g., non-drive wheels) at a base of the topper cart. In some embodiments, the topper cart includes a wheel at each corner of the topper cart. In some embodiments, a topper-specific cart is designed/configured to have one or more wheels at non-corner locations, e.g., to improve stability and/or load balancing. In some embodiments, the frame of the topper cart has a geometry that is configured to mount the topper with high cleanability (e.g., the frame is easily accessible for cleaning and interfaces with the topper itself in a manner that promotes cleaning of the topper as well). In some embodiments, the AMR and/or the topper cart includes a low-mounted toe guard that protects against toe crushing and allows for an open and easily cleanable structure. In some embodiments, the AMR integrates safety-friendly features including a toe guard and a 360-degree safety laser scanner coverage.

In some embodiments, the AMR includes a linkage component (e.g., a compliant linkage) that is configured to connect the core and the topper cart to allow control while accommodating driving surface irregularities. In some embodiments, the linkage component includes controlled degrees of freedom about two orthogonal horizontal axes (e.g., a pitch axis and a roll axis). The linkage component allows the topper cart to have undriven caster wheels in each corner to give a wide base of support to the topper, while the AMR's mobility is controlled by drive wheels rigidly attached to the core. Because the linkage connecting the core and the cart is compliant, the drive wheels stay in contact with the driving surface, even in the presence of surface irregularities. As a first example, the AMR may have a width of 500 millimeters (mm), a length of 700 mm, and a height of 380 mm. The AMR in this example may have a weight of 62 kilograms (kg) and be able to support a payload weight of about 80 kg. For this AMR, the linkage component may have a width/diameter in the range of 20 mm to 60 mm and a length in the range of 50 mm to 300 mm. In another example, the AMR may have a width of about 950 mm, a length of about 1200 mm, and a height of 320 mm. The AMR in this example may have a weight of 220 kg and be able to support a payload weight of about 900 kg. For this AMR, the linkage component may have a width/diameter in the range of 50 mm to 75 mm and a length in the range of 50 mm to 400 mm.

In some embodiments, the AMR is battery operated. In some embodiments, the AMR battery is charged via wireless charging. In some embodiments, the AMR battery is charged via contactless charging, using a contactless charging configuration that has high cleanability.

In accordance with some embodiments, an AMR includes (i) a set of one or more functional components enclosed in a sealed housing; (ii) a set of sensors configured to monitor a vicinity of the AMR; (iii) a compliant linkage configured to connect the sealed housing to a topper cart with relative movement between the sealed housing and the topper cart in two degrees of freedom; and (iv) a set of drive wheels coupled to the sealed housing and configured to enable movement of the AMR. In some embodiments, the sealed housing is configured such that surfaces of the sealed housing are accessible for hand cleaning without dismantling the AMR. In some embodiments, the AMR further includes the topper cart. The topper cart includes a frame configured to support a topper component and a plurality of non-drive wheels positioned at a base of the frame. In some embodiments, the compliant linkage comprises a rotary joint. In some embodiments, the compliant linkage is composed of a stainless steel material. In some embodiments, the compliant linkage is configured to allow the set of drive wheels to move about a pitch axis and a roll axis with respect to the topper cart. In some embodiments, the set of one or more functional components comprises one or more of: an energy storage device, control circuitry, a drive wheel gearbox, a battery, and a charger configured to charge the battery. In some embodiments, the AMR is an autonomous guided vehicle.

Note that the various embodiments described herein can be combined with any other embodiments described herein. Further, the aspects described with respect to AMRs can also be applied to other autonomous equipment, such as tuggers, power lifts, and autonomous forklifts.

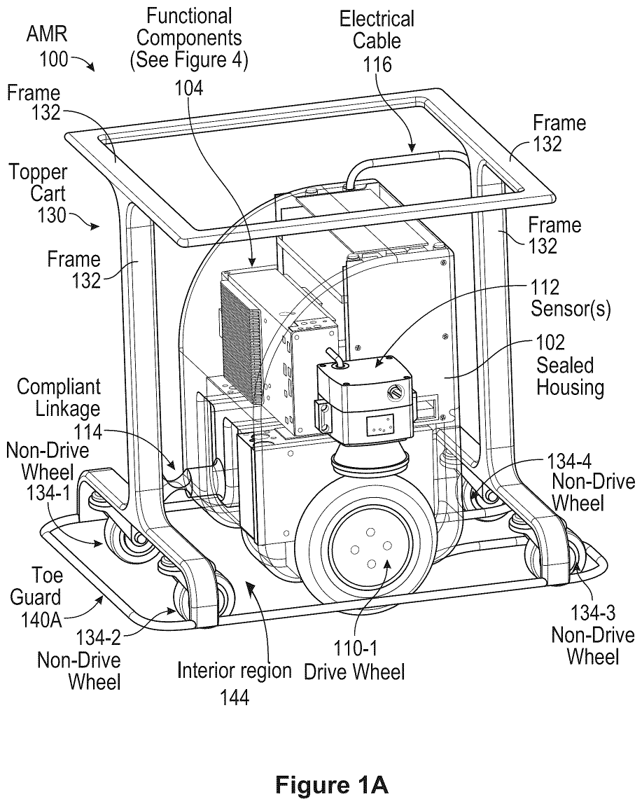

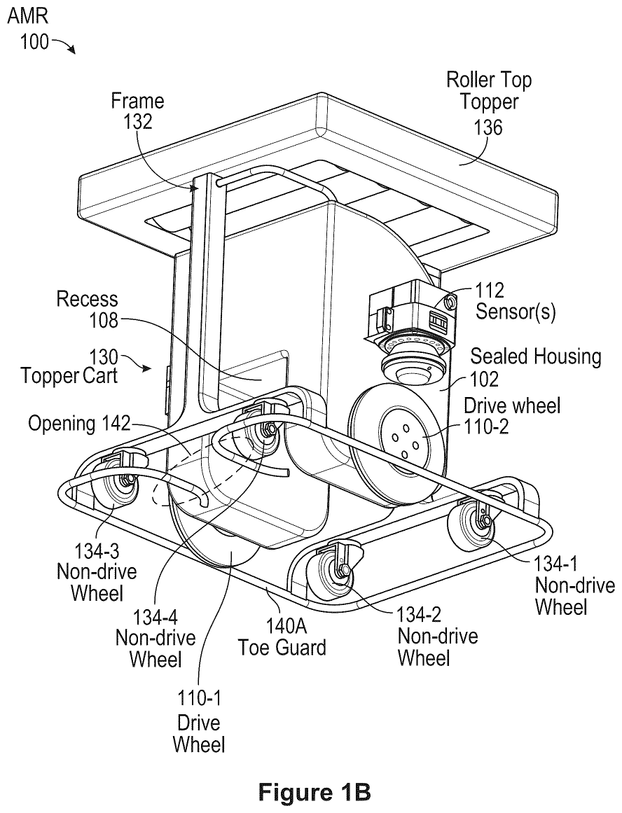

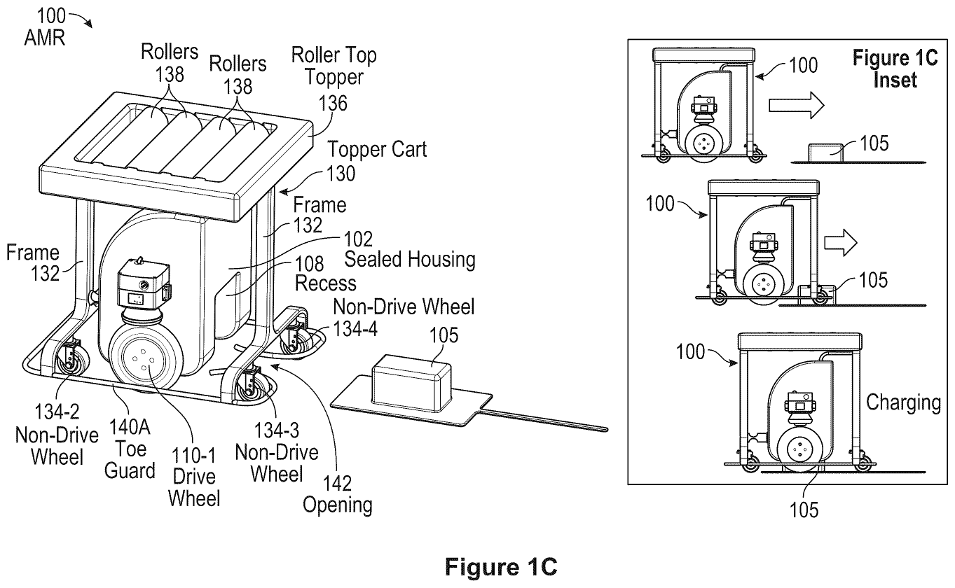

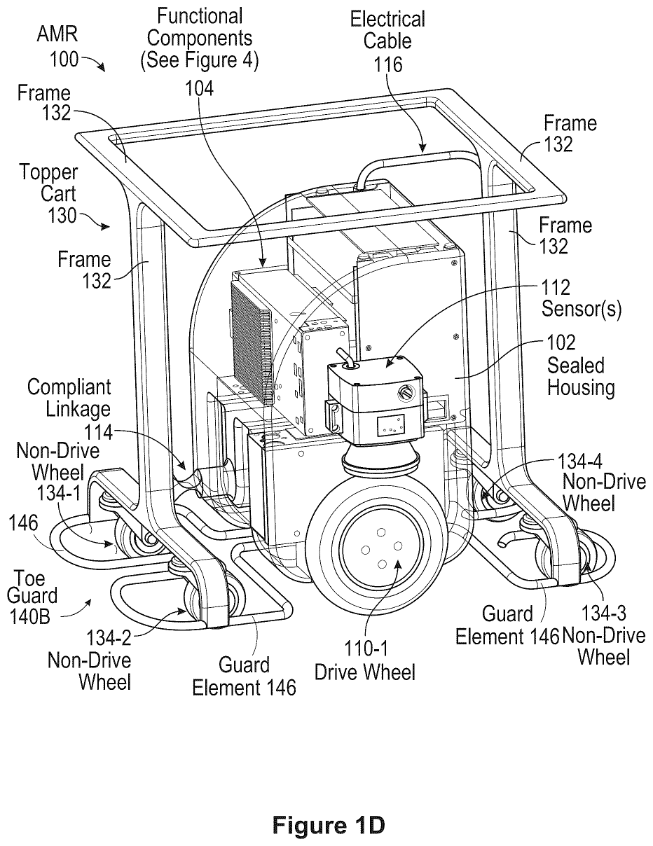

Referring now to the figures, FIGS. 1A, 1B, and 1C illustrate example views of an AMR 100 in accordance with some embodiments. In accordance with some embodiments, the AMR 100 is adapted and configured to operate in a sterile environment designed to minimize the accumulation or transportation of germs, bacteria, and other microorganisms. Example sterile environments include environments that are used in the production of medicine, pharmaceutical products, and/or food.

In some embodiments, the AMR 100 (e.g., most components, external components, or all components of the AMR) is composed of cleanroom materials, such as materials that may be cleaned by hand using isopropanol (isopropyl alcohol). In some embodiments, the AMR 100 is composed of materials that may be cleaned using a vaporized hydrogen peroxide (VHP) process. In some embodiments, the AMR is composed of materials that are compliant with one or more manufacturing standards for pharmaceutical/medicinal environments. For example, the AMR 100 may be composed of materials that comply with the Good Manufacturing Practice (GMP) from the European Medicines Agency (EMA). As an example, the AMR 100 may be configured for environmental monitoring, material transport, surface sampling, line clearance, and/or other functions/tasks.

In accordance with some embodiments, the AMR 100 includes a sealed housing 102. In some embodiments, the sealed housing 102 is designed (e.g., adapted) to have open and easily accessible surfaces to facilitate cleanability. In some embodiments, the sealed housing 102 is configured such that surfaces of the sealed housing 102 are accessible for hand cleaning without dismantling the AMR 100. In some embodiments, the sealed housing 102 is designed/adapted to allow for hand cleaning. In some embodiments, the sealed housing 102 is configured to prevent pathogens from entering the housing. In some embodiments, the sealed housing 102 comprises hermetically sealing (e.g., the sealed housing 102 is hermetically sealed). In some embodiments, the sealed housing 102 is composed of a plastic (e.g., medical-grade polymers such as PEEK, PTFE, and PPSU) or silicone. In some embodiments, the sealed housing 102 is composed of stainless steel. In some embodiments, the sealed housing is composed of materials and/or configured to be cleaned via a VHP process (e.g., without subsequently releasing VHP vapor during AMR operation). In some embodiments, the sealed housing 100 has a smooth texture or surface (e.g., to promote cleaning). For example, the sealed housing 102 may be configured without crevices, cracks, and/or openings that would be difficult to hand clean and/or would allow dirt/debris into an interior of the housing.

In accordance with some embodiments, the AMR 100 includes functional components 104. FIG. 1A illustrates the functional components 104 being enclosed in the sealed housing 102. The functional components 104 in the sealed housing 102 may be referred to as a “functional core” or a “sealed functional core” of the AMR 100. In some embodiments, the functional components 104 include control circuitry, communication circuitry, an energy storage device, and/or drive wheel control circuitry. Enclosing the functional components 104 in the sealed housing 102 provides practical and regulatory advantages in sterile and cleanroom environments. By isolating electronics and cabling of the circuitries from the external environment, the AMR 100 reduces particle generation and prevents ingress of bacteria, spores, dust, and cleaning fluids, and in turn supports cleanroom compliance.

In the embodiments, the functional components 104 include an energy storage device 452 that is configured to power (e.g., provide electrical energy to) the AMR 100 and/or power a drive system of the AMR. In some embodiments, the energy storage device 452 comprises a battery 454. In some embodiments, the functional components 104 includes a charger 106 (e.g., a battery charger) that is configured to charge the battery 454. In some embodiments, the charger comprises a wireless charger. In some embodiments, the charger 106 is configured to wirelessly charge the battery 454 using electromagnetic induction. In some instances, for example, the wireless charger may be configured for contactless charging. In accordance with some embodiments, AMR chargers that are used in sterile environments are adapted to be cleanable (e.g., can be cleaned by hand or using a VHP process). One method of wireless charging for conventional AMRs involves placing an inductive charging pad on the floor so that an AMR can drive over, park, and receive a charge. This methodology may not be suitable for sterile environments because the charging design and mechanism the AMRs require a large surface of the AMR to be close to the ground, which affects cleanability since it is difficult for a technician to reach underneath the robot to clean. Some embodiments of the present disclosure address the challenges associated with cleanability by elevating an inductive charging pad off the floor, so that the mating charge received on the AMR 100 can be elevated as well.

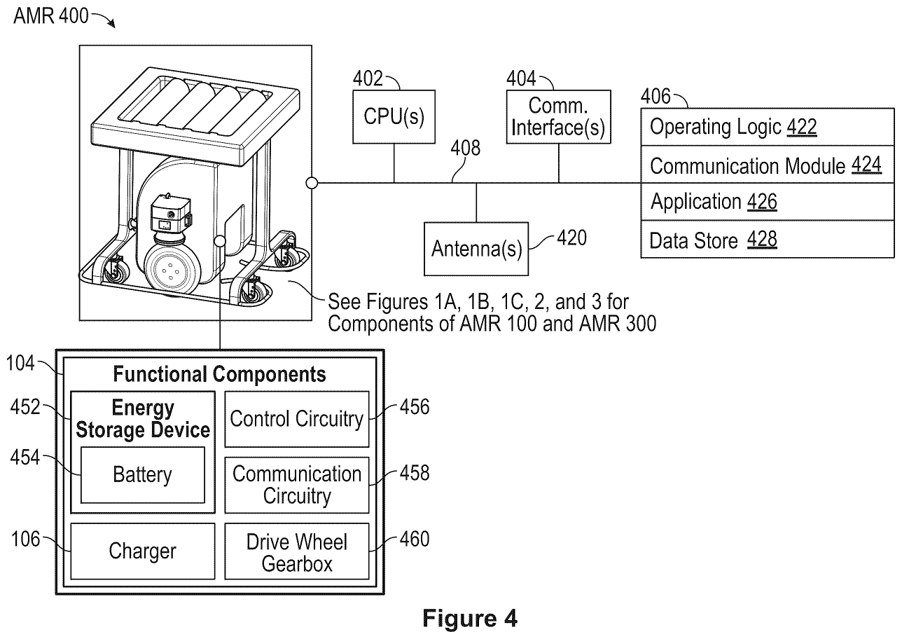

In accordance with some embodiments, the sealed housing 102 of the AMR 100 includes a recess 108 at the bottom of the sealed housing. In some embodiments, the recess 108 is shaped to allow an inductive charging component (e.g., the charging component 105) to be positioned within, and a wireless charger component (e.g., the charger 106, FIG. 4) is positioned adjacent to the recess to receive wireless charging from the inductive charging component. For example, FIG. 1C inset shows that in some embodiments, the AMR 100 can drive over the charging component 105. While the AMR 100 is over (e.g., above) the charging component 105, the charging component 105 is positioned below the recess 108 and is configured to charge the AMR 100 (e.g., charge the charger 106 that is positioned adjacent to the recess 108). In some embodiments, the recess 108 is of sufficient size to allow the charger 106 to be charged via the charging component 105. In some embodiments, the recess 108 is of sufficient size (and other adapted) to allow for hand cleaning of the sealed housing surfaces. For example, the sealed housing 102 is positioned so as to allow for hand cleaning of the bottom surface without requiring a user to tip or turn over the AMR 100.

In some embodiments, the wireless charger is configured to receive power signals from an inductive charging device (e.g., the charging component 105) on a surface while the inductive charging device is positioned in the recess 108 at the bottom of the sealed housing 102. In some embodiments, a portion of the sealed housing 102 defining the recess 108 is composed of a dielectric material. For example, the bottom of the sealed housing 102 may be composed of silicone or plastic material (not steel) (e.g., to promote wireless charging) whereas other portions of the sealed housing 102 may be composed of stainless steel.

In some embodiments, the functional components 104 include control circuitry (e.g., control circuitry 456, FIG. 4). The control circuitry may include one or more controllers and/or one or more processors (e.g., one or more CPUs such as CPU(s) 402, a microprocessor, and/or other type of processor). In some embodiments, the control circuitry 456 comprises, or is in communication with, communication circuitry 458 (e.g., including one or more communication interfaces, such as communication interfaces 404), for communicating with one or more external devices and/or internal components. For example, the communication circuitry 458 may be configured to wirelessly communicate with other devices/systems in the local environs of the AMR 100. In some embodiments, the communication circuitry 458 is configured to communicate with a topper component mounted to a topper cart 130 (e.g., via a wired connection).

In some embodiments, the functional components 104 include a drive wheel gearbox 460 that is configured to deliver power to one or more drive wheels 110 (e.g., drive wheel 110-1 and drive wheel 110-2), for enabling movement of the AMR 100. As illustrated in FIGS. 1A, 1B, and 1C, in some embodiments the drive wheels 110 are coupled to the sealed housing 102. In some embodiments, the drive wheels 110 comprise two drive wheels (e.g., drive wheel 110-1 and drive wheel 110-2) arranged on opposite sides of the sealed housing 102. In some embodiments, the drive wheels 110 are rigidly attached to the drive wheel gearbox 460, and the drive wheel gearbox 460 is located in the sealed housing 102. In some embodiments, the drive wheels 110 are composed of non-marking, non-shedding elastomers. In some embodiments, the drive wheels 110 are composed of solid polyurethane. In some embodiments, the drive wheels 110 are composed of sealed hubs and bearings. In some embodiments, the drive wheels 110 are composed of conductive treads that prevent static buildup by creating a path to discharge electricity into flooring, thereby protecting sensitive electronics and equipment. In some embodiments, the drive wheel gearbox 460 comprises a lubrication-free gearbox that utilizes plastics and/or magnetic technology to eliminate the need for oil or grease. In some embodiments, the drive wheel gearbox 460 uses food or medical-grade gear lubricants that are compatible for use in food processing, packaging, and/or pharmaceutical manufacturing facilities.

In some embodiments, the AMR 100 includes a set of sensors (e.g., one or more sensors 112) that are configured to monitor a vicinity of the AMR 100. Example sensors 112 include, and are not limited to, imaging sensors, laser scanners, sonar sensors, radar sensors, light sensors, movement sensors, position sensors, orientation sensors, movement sensors, pressure sensors, audio sensors, impact sensors, and/or Light Detection and Ranging (LiDAR) sensors.

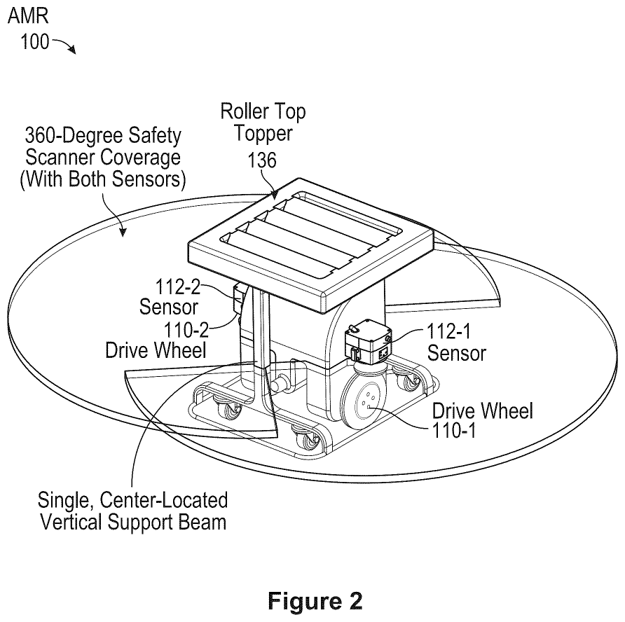

FIG. 2 illustrates an example sensor configuration on AMR 100 in accordance with some embodiments. In the example of FIG. 2, sensors 112-1 and 112-2 are mounted on an exterior of the sealed housing 102, where each of the sensors is positioned at a respective side of the housing 102. In some embodiments, the sensors 112 may be positioned within the sealed housing 112 (e.g., in an interior of the sealed housing). In some embodiments, a first subset of the sensors 112 are positioned on an exterior of the sealed housing 112 and a second subset of the sensors 112 are positioned in an interior of the sealed housing 112. In some embodiments, a respective sensor 112 is positioned adjacent to a respective drive wheel. For example, FIG. 2 shows the sensor 112-1 positioned above drive wheel 110-1, and the sensor 112-2 is positioned above drive wheel 110-2.

In some embodiments, the sensors 112 comprise laser-based sensors. In some embodiments, the AMR 100 includes one or more sensors positioned within the sealed housing 102. In some embodiments, the AMR 100 includes one or more sensors attached to the drive wheels 110. For example, the sensors may include one or more odometers and/or one or more encoders that are configured to collect odometry information of the AMR 100. In some embodiments, the sensors 112 are configured to collect and transmit safety-related information, as well as collect and transmit information used for navigation (e.g., the sensors 112 are configured to perform dual functions of safety and navigation). In some embodiments, the sensors 112 are configured and arranged to provide 360-degree scan coverage around the AMR 100, as illustrated in FIG. 2.

In some embodiments, the control circuitry 456 is configured to process sensor data from the sensors 112 and adjust operation of the AMR 100 accordingly. For example, in some embodiments, the control circuitry 456 is configured to trigger an alert when an object (e.g., people, machinery, other obstacles) is detected in the vicinity of the AMR 100.

In accordance with some embodiments, the AMR 100 includes a topper cart 130. The topper cart 130 may include a frame 132 (e.g., a structure that includes one or more beams or columns). In some embodiments, the frame 132 is composed of a cleanroom material. For example, the frame 132 may be composed of stainless steel, or other suitable material that may be cleaned by hand or with cleaning chemicals such as vaporized hydrogen peroxide or IPA. In some embodiments, the frame of the AMR includes at most a single beam support on each side. For example, the frame may use a single support (instead of 2 or more supports) in order to provide the sensors of the AMR with more coverage (e.g., allowing for 360 degree coverage).

In some embodiments, the frame 132 is configured to support a topper component. A topper component (or simply a “topper”) is typically located on top on an AMR and forms the functional payload of the AMR. AMRs are typically considered an incomplete portion of an integrated final solution, whereas a topper is part of the complete integrated solution that the AMR moves around.

In some embodiments, the frame 132 is configured for a particular type of topper component. In accordance with some embodiments, the topper cart 130 (e.g., frame 132) can be made “topper-specific,” meaning that the cart and/or frame can be tailored to the topper component itself. An example topper component is a deck load platform topper, which is an area on top of an AMR (e.g., on top of topper cart 130) on which packages or other payloads can be placed for transport. Another example of a topper component is a roll-top topper, which includes a set of rollers (e.g., actuated) for receiving payloads (e.g. at a pickup location) and for discharging payloads (e.g. at a drop-off location). For example, FIGS. 1B and 1C illustrate one configuration where the topper cart 130 is fitted with a roller top topper 136 that includes a set of rollers 138. Another example of a topper component is a manipulator topper, which comprises one or more mechanisms (e.g. robot arms) that can be used to perform manipulation-based tasks such as picking sample containers and pressing them against cleanroom surfaces to measure surface contamination in the cleanroom.

In some embodiments, the topper cart 130 includes a plurality of non-drive wheels 134 (e.g., non-drive wheels 134-1, 134-2, 134-3, and 134-4) positioned at a base of the frame 132, as illustrated in FIGS. 1A, 1B, and 1C. In some embodiments, the non-drive wheels 134 comprise caster wheels. In some embodiments, each non-drive wheel 134 is positioned at a respective corner of the topper cart 130. For example, the topper cart 130 may have undriven caster wheels in each corner to give a wide base of support to the topper, while the AMR's mobility is controlled by the drive wheels 110 that are rigidly attached to the sealed housing 102.

In some embodiments, the topper cart 130 includes a toe guard 140 (e.g., toe guard 140A in FIGS. 1A to 1C and toe guard 140B in FIG. 1D) that is configured to prevent the wheels (e.g., drive wheels 110 and/or non-drive wheels 134) from rolling over a person's foot. For example, the toe guard 140 is configured to avoid injury to the feet of persons standing nearby the AMR 100. As an example, the toe guard 140 may be configured to comply with one or more safety standards, such as ISO 3691-4:2023. In some embodiments, the toe guard 140 is configured to be hand cleanable.

In some embodiments, the toe guard 140 is positioned proximate to the base of the topper cart and arranged to surround, or partially surround, the plurality of non-drive wheels 134. FIGS. 1A to 1C illustrate a first embodiment showing the toe guard 140A as a continuous or substantially continuous guard structure that encircles a perimeter enclosing all the drive wheels 110 and the non-drive wheels 134 of the AMR 100. The guard structure extends outward from the base of the frame 132 to form a protective boundary around the collective wheel area, thereby preventing inadvertent contact with any wheel from outside the perimeter. The toe guard 140A may define an open interior region 140 within which the drive wheels 110 and the non-drive wheels 134 of the AMR 100 are free to rotate and articulate, while the exterior boundary remains fixed relative to the frame 132. As illustrated in FIGS. 1A to 1C, the guard structure may comprise a bar (e.g., that is made of stainless steel and/or a material that can withstand cleaning chemicals such as IPA or hydrogen peroxide). In some embodiments, the guard structure comprises a smooth, unbroken exterior surface that can facilitate manual wipe-down cleaning and vaporized hydrogen peroxide exposure. The toe guard 140A can be mounted to the topper cart frame 132 via minimal-contact standoffs, such as sealed, radiused brackets, that provide structural rigidity while reducing crevice formation. In some embodiments, the toe guard 140 is located at a predefined height configured to intercept rolling contact of the drive wheels 110 and non-drive wheels 134 with a human foot while maintaining ground clearance sufficient to avoid snagging on minor floor irregularities.

FIG. 1D illustrates a second embodiment showing toe guard 140B as having multiple discrete guard elements 146. In this example, each guard element 146 is positioned adjacent to and surrounding a respective non-drive wheel 134 of the AMR 100. Each guard element 146 defines a protective barrier extending around the outer perimeter of its associated wheel, thereby limiting user contact with the wheels during operation. The guard elements 146 also provide toe guard functionality for the middle drive wheels 110 that are not surrounded by the guard elements. The individual guard elements 146 are fixed relative to the frame 132 and are spaced to allow the non-drive wheels to have normal wheel rotation. The toe guard 140B (e.g., guard elements 146) may be made of stainless steel and/or another material that can withstand cleaning chemicals. The guard elements 146 in FIG. 1D include a gap in both the front and back of the AMR (e.g., to allow the AMR to move over a charging device in forward or reverse orientation). In some embodiments, one or more of the guard elements 146 fully enclose one or more wheels. As with the toe guard 140A in FIG. 1A, the guard elements 146 are not attached to, or in contact with, the sealed house 102 (e.g., so that the housing may move relative to the guard elements 146 via the compliant linkage 114).

In some embodiments, the toe guard 140 further define one or more openings to enable interaction with floor-mounted or elevated infrastructure. For example, FIGS. 1B and 1C show the toe guard 140A includes an opening 142 configured to enable interaction between the AMR 100 and floor-mounted or elevated infrastructure, including inductive charging components positioned beneath the AMR, such that the AMR 100 can drive over the charging component 105. In some embodiments, the AMR 100 includes a compliant linkage 114 configured to connect the sealed housing 102 to the topper cart 130, with relative movement between the sealed housing 102 and the topper cart 130 in two degrees of freedom (e.g., movement with respect to a pitch axis and a roll axis).

In some embodiments, the plurality of non-drive wheels 134 are arranged in a suspension drive configuration via the compliant linkage 114 with respect to the set of drive wheels 110. For example, in some embodiments, the compliant linkage 114 is configured to move about a pitch axis and a roll axis with respect to the topper cart 130. For example, the compliant linkage 114 allows control while accommodating driving surface irregularities. Because the other end of the compliant linkage 114 is connected to the sealed housing 102, and the sealed housing 102 is coupled to the drive wheels 110, the functional components 104 enclosed inside the sealed housing 102 are configured to “pitch and roll” via the compliant linkage 114. The compliant linkage 114 may be configured to allow the drive wheels 110 to maintain contact with an uneven floor by allowing the non-drive wheels 134 of the topper cart 130 to move independently of the drive wheels within a given range.

In some embodiments, the compliant linkage 114 comprises a rotary joint architecture with a primary roll axis located laterally across the cart interface and a secondary pitch axis located fore-aft, implemented as two orthogonal shafts in a compact knuckle assembly (e.g., a knuckle rotary joint). The knuckle rotary joint can include a joint housing that comprises stainless steel with welded closures. The joint housing may include a reduced/minimal number of fasteners and/or fasteners that are made captive with sealed heads to reduce particle traps. This arrangement can allow the topper cart's non-drive caster wheels to articulate independently of the drive wheels, ensuring continuous traction while the core pitches and rolls within defined angular limits.

In some embodiments, the compliant linkage 114 comprises a yoke arm. For example, the yoke arm may be coupled to the sealed housing 102 via a cross-pin roll joint and to the topper cart 130 via a clevis-style pitch joint. The yoke arm may be formed from a single bent or machined stainless element with smooth contours and polished surfaces. Bushings can be formed from a non-shedding, chemically resistant polymer and retained by sealed collars. In some embodiments, end stops are integrated to limit angular travel and prevent excessive tilt (e.g., which may compromise a sensor field-of-view or payload stability). The yoke arm can provide an easily cleanable structure with sufficient compliance to accommodate typical cleanroom floor irregularities.

In some embodiments, the compliant linkage 114 comprises a combination flexure and rotary joint. The combination flexure and rotary joint can allow rotational motion through material deformation rather than sliding or rolling. For example, a thin, compliant stainless plate or leaf element can provide low-angle pitch accommodation while a coaxial rotary bearing provides roll compliance. The flexure element can be sized to remain in the elastic regime under operational loads and impact events, e.g., with filleted cutouts to prevent stress concentration. The flexure can be enclosed by a smooth guard shell that maintains cleanability while allowing visible inspection.

In some embodiments, the compliant linkage 114 is composed of a stainless steel material. For example, the compliant linkage 114 may be composed of a stainless steel yoke arm with while a dissimilar metal (e.g., not stainless steel), plastic, or silicone may be used as a bushing material. In some embodiments, the compliant linkage 114 is composed of one or more cleanroom materials.

In some embodiments, the AMR 100 includes an electrical cable 116 that penetrates the sealed housing 102. In some embodiments, the electrical cable 116 is configured to electrically couple the one or more functional components 104 with the topper component mounted on the topper cart 130. In some embodiments, the electrical cable 116 provides power and/or control signals from the functional components 104 to the topper component. In some embodiments, the electrical cable 116 includes a sheathing and connector that complies with one or more cleanroom standards (e.g., the GMP). In some embodiments, the electrical cable 116 comprises a flexible electrical cable that connects the functional components 104 with the topper cart 130 (e.g., the energy storage device 452 and/or battery 454 of the AMR 100 is also used for powering the topper components).

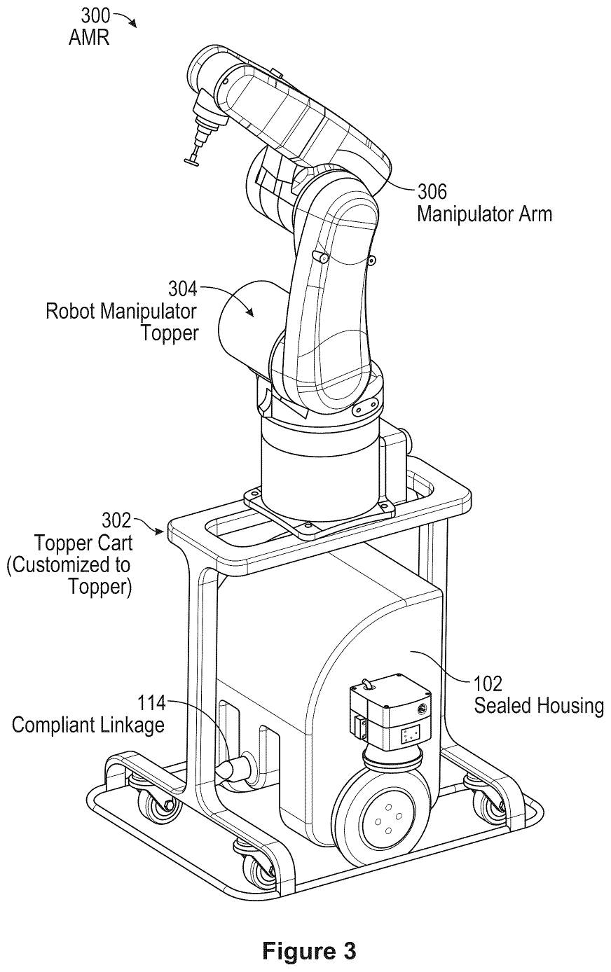

FIG. 3 illustrates an AMR 300 having a configuration that includes a robot manipulator topper 304 with a manipulator arm 306 (e.g., a mobile manipulator) mounted on a top surface of topper cart 302. Another example of a topper component is a special equipment topper, which is a piece of equipment for designated purposes. An example piece of equipment can be an environmental monitoring equipment. For instance, the pharmaceutical industry may desire to use AMRs to transport environmental monitoring equipment (e.g., to measure for contamination in the cleanroom air) to various locations in cleanrooms to take measurements. In some instances, the topper component can include any other type of topper not described above. The AMR 100 and 300 may include a same set of functional components, a same sealed housing 102, a same set of drive wheels, and a same compliant linkage 114 (e.g., the core component is unchanged when the topper cart is customized to a particular topper component). The topper cart 302 may include any of the features and aspects described herein with respect to the topper cart 130.

FIG. 4 is a block diagram of an AMR 400 (e.g., an instance of AMR 100 or AMR 300) in accordance with some embodiments. In some embodiments, the AMR 400 includes a sealed housing 102, which is described with reference to FIGS. 1A, 1B, 1C, 2, and 3. In some embodiments, the AMR 400 includes drive wheels 110, which are described with reference to FIGS. 1A, 1B, and 1C. In some embodiments, the AMR 400 includes sensors 112, which are described with reference to FIGS. 1A, 1B, 1C, and 2. In some embodiments, the AMR 400 includes a compliant linkage 114, which is described with reference to FIGS. 1A, 1B, 1C, and 3. In some embodiments, the AMR 400 includes a topper cart 130 or a topper cart 302, which is described with reference to FIGS. 1A, 1B, 1C, 2, and 3. In some embodiments, the topper cart includes a frame 132, non-drive wheels 134, a toe guard 140, and/or a configurable topper such as roller top topper 136 or robot manipulator topper 304, which are described with reference to FIGS. 1A, 1B, 1C, 2, and 3.

In some embodiments, the AMR 400 includes a set of (one or more) functional components 104. In some embodiments, the functional components 104 include one or more of an energy storage device 452, a battery 454, a charger 106, a control circuitry 456, a communication circuitry 458, and a drive wheel gearbox 460, which are described with respect to FIGS. 1A, 1B, 1C, 2, and 3. In some embodiments, the AMR 400 includes one or more processors (e.g., CPU(s)) 402, one or more communication interface(s) 404 (e.g., network interface(s)), memory 406, and one or more communication buses 408 for interconnecting these components (sometimes called a chipset).

In some embodiments, the AMR 400 includes antenna(s) 420. The antenna(s) 420 enable one or more communication networks, and allow the AMR 400 to communicate with other devices. In some embodiments, the antenna(s) 420 are capable of data communication using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, Ultrawide Band (UWB), 4G LTE, 5G, and/or software defined radio (SDR)) custom or standard wired protocols (e.g., Ethernet or HomePlug), and/or any other suitable communication protocol, including communication protocols not yet developed as of the filing date of this patent application.

In some embodiments, the memory 406 includes high-speed random-access memory, such as DRAM, SRAM, DDR RAM or other random-access solid-state memory devices. In some implementations, the memory 406 includes non-volatile memory, such as one or more magnetic disk storage devices, optical disk storage devices, flash memory devices. or other non-volatile solid-state storage devices. In some implementations, the memory 406 includes one or more storage devices remotely located from the CPU(s) 402. The memory 406, or alternately the non-volatile memory device(s) within the memory 406, comprises a non-transitory computer-readable storage medium. In some implementations, the memory 406, or the computer-readable storage medium of the memory 406, stores the following programs, modules, and data structures, or a subset thereof:
operating logic 422 (e.g., an operating system and/or firmware), which includes procedures for handling various basic system services and for performing hardware dependent tasks;
a communications module 424, which is used for connecting the AMR 400 to other devices via the one or more communication interfaces 404 (wired or wireless) and one or more communication networks, such as the Internet, other wide area networks, local area networks, metropolitan area networks, and so on;
an application 426, for controlling one or more components of the AMR 400, such as controlling monitoring functions of the sensors 112; and
a data store 428 (e.g., a database) storing information for the AMR 400, such as location information, geography information, task information, device information, and/or other types of data.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 406 stores a subset of the modules and data structures identified above. Furthermore, the memory 406 may store additional modules or data structures not described above.

Although FIG. 4 shows an AMR 400, FIG. 4 is intended more as a functional description of the various features that may be present rather than as a structural schematic of the implementations described herein. In practice, and as recognized by those of ordinary skill in the art, items shown separately could be combined and some items could be separated.

Turning now to some example embodiments.
(A1) In one aspect, some embodiments include an autonomous mobile robot (AMR). In some embodiments, the AMR includes (i) a set of one or more functional components (e.g., functional components 104) enclosed in a sealed housing (e.g., sealed housing 102); (ii) a set of sensors (e.g., sensors 112) configured to monitor a vicinity of the AMR; (iii) a compliant linkage (e.g., compliant linkage 114) configured to connect the sealed housing to a topper cart (e.g., topper cart 130 or topper cart 302) with relative movement between the sealed housing and the topper cart in two degrees of freedom; and (iv) a set of drive wheels (e.g., drive wheels 110) coupled to the sealed housing and configured to enable movement of the AMR.
(A2) In some embodiments of A1, the sealed housing is configured such that surfaces of the sealed housing are accessible for hand cleaning without dismantling the AMR. In some embodiments, the sealed housing is configured such that all exterior surfaces are reachable by a cleaning technician using standard cleaning implements. In some embodiments, the sealed housing lacks recessed fasteners, hidden cavities, or overlapping panels that would trap contaminants or require disassembly for cleaning. In some embodiments, the sealed housing includes smooth, continuous exterior surfaces. In some embodiments, the sealed housing includes radiused edges and corners. In some embodiments, the sealed housing is configured to be cleaned while the AMR remains in an operational configuration.
(A3) In some embodiments of A1 or A2, the AMR further includes the topper cart (e.g., topper cart 130 or topper cart 302), wherein the topper cart comprises: (i) a frame (e.g., frame 132) configured to support a topper component; and (ii) a plurality of non-drive wheels (e.g., non-drive wheels 134) positioned at a base of the frame. In some embodiments, the frame comprises one or more vertical beams. In some embodiments, the frame comprises one or more horizontal members. In some embodiments, the frame comprises tubular stainless steel members. In some embodiments, the frame comprises welded joints. In some embodiments, the frame comprises polished surfaces. In some embodiments, the plurality of non-drive wheels comprises caster wheels. In some embodiments, the plurality of non-drive wheels comprises swivel casters. In some embodiments, the plurality of non-drive wheels comprises four non-drive wheels. In some embodiments, the plurality of non-drive wheels comprises sealed bearings. In some embodiments, the plurality of non-drive wheels comprises non-marking wheel materials.
(A4) In some embodiments of A3, each wheel of the plurality of non-drive wheels is positioned at a respective corner of the topper cart. In some embodiments, the non-drive wheels are positioned at four corners of a rectangular footprint. In some embodiments, the non-drive wheels are positioned at outermost positions of the topper cart base. In some embodiments, one or more non-drive wheels are positioned at non-corner locations. In some embodiments, one or more non-drive wheels are positioned at intermediate positions along an edge of the topper cart. In some embodiments, the positioning of the non-drive wheels is selected based on a weight distribution of a topper component.
(A5) In some embodiments of A3 or A4, the topper cart further comprises a toe guard (e.g., toe guard 140A or toe guard 140B) configured to prevent the set of drive wheels from rolling over a person's foot. In some embodiments, the toe guard comprises stainless steel. In some embodiments, the toe guard comprises a cleanroom-compatible material. In some embodiments, the toe guard comprises a continuous guard structure that encircles a perimeter enclosing the drive wheels and the non-drive wheels. In some embodiments, the toe guard comprises multiple discrete guard elements. In some embodiments, each guard element is positioned adjacent to and at least partially surrounding a respective non-drive wheel. In some embodiments, the toe guard comprises smooth, continuous profiles. In some embodiments, the toe guard comprises radiused corners. In some embodiments, the toe guard comprises sealed joints. In some embodiments, the toe guard comprises a bar. In some embodiments, the toe guard comprises a tubular member. In some embodiments, the toe guard defines an open interior region within which the drive wheels and the non-drive wheels are free to rotate. In some embodiments, the toe guard is mounted to the topper cart frame via standoffs. In some embodiments, the toe guard is mounted to the topper cart frame via sealed brackets. In some embodiments, the toe guard defines one or more openings configured to enable interaction with floor-mounted infrastructure. In some embodiments, the toe guard defines an opening configured to allow an inductive charging component to be positioned beneath the AMR. In some embodiments, the toe guard is positioned at a predefined height above a floor surface.
(A6) In some embodiments of any of A1-A5, the frame has a geometry that is configured to support a predefined topper component. In some embodiments, the predefined topper component comprises a deck load platform. In some embodiments, the predefined topper component comprises a roll-top topper. In some embodiments, the predefined topper component comprises a manipulator topper. In some embodiments, the predefined topper component comprises environmental monitoring equipment. In some embodiments, the frame geometry includes mounting points corresponding to the predefined topper component. In some embodiments, the frame geometry includes structural reinforcements corresponding to an expected weight of the predefined topper component. In some embodiments, the frame geometry includes cable routing paths corresponding to the predefined topper component.
(A7) In some embodiments of any of A1-A6, the compliant linkage comprises a rotary joint. In some embodiments, the rotary joint comprises a knuckle rotary joint. In some embodiments, the rotary joint comprises two orthogonal shafts. In some embodiments, the rotary joint comprises a compact knuckle assembly. In some embodiments, the rotary joint comprises a primary roll axis located laterally across a cart interface. In some embodiments, the rotary joint comprises a secondary pitch axis located fore-aft. In some embodiments, the rotary joint comprises a joint housing. In some embodiments, the joint housing is composed of stainless steel. In some embodiments, the joint housing comprises welded closures. In some embodiments, the rotary joint comprises sealed fastener heads. In some embodiments, the rotary joint comprises captive fasteners. In some embodiments, the compliant linkage comprises a yoke arm. In some embodiments, the yoke arm is coupled to the sealed housing via a cross-pin roll joint. In some embodiments, the yoke arm is coupled to the topper cart via a clevis-style pitch joint. In some embodiments, the yoke arm comprises a single bent stainless element. In some embodiments, the yoke arm comprises a machined stainless element. In some embodiments, the yoke arm comprises polished surfaces. In some embodiments, the compliant linkage comprises bushings. In some embodiments, the bushings comprise a non-shedding polymer. In some embodiments, the bushings comprise a chemically resistant polymer. In some embodiments, the compliant linkage comprises end stops configured to limit angular travel. In some embodiments, the compliant linkage comprises a combination flexure and rotary joint. In some embodiments, the combination flexure and rotary joint comprises a thin compliant plate. In some embodiments, the combination flexure and rotary joint comprises a leaf element. In some embodiments, the combination flexure and rotary joint comprises a coaxial rotary bearing.
(A8) In some embodiments of any of A1-A7, the compliant linkage is composed of a stainless steel material. In some embodiments, the compliant linkage comprises a stainless steel yoke arm. In some embodiments, the compliant linkage comprises a stainless steel joint housing. In some embodiments, the compliant linkage comprises a bushing material that is different from stainless steel. In some embodiments, the bushing material comprises a different metal. In some embodiments, the bushing material comprises plastic. In some embodiments, the bushing material comprises silicone. In some embodiments, the compliant linkage is composed of one or more cleanroom-compatible materials.
(A9) In some embodiments of any of A1-A8, the compliant linkage is configured to allow the set of one or more functional components enclosed in the sealed housing to move about a pitch axis and a roll axis with respect to the topper cart. In some embodiments, the compliant linkage is configured to allow the sealed housing to pitch within defined angular limits. In some embodiments, the compliant linkage is configured to allow the sealed housing to roll within defined angular limits (e.g., in a range of 5-15 degrees). In some embodiments, the compliant linkage is configured to allow the drive wheels to maintain contact with a driving surface in the presence of surface irregularities. The surface irregularities can include expansion gaps (e.g., horizontal gaps in the range of 5-20 mm), vertical steps (e.g., up to 1 centimeter), and/or surface variations (e.g., up to ⅛^{th} inch or ¼ inch). In some embodiments, the compliant linkage is configured to allow the non-drive wheels of the topper cart to move independently of the drive wheels within a given range. In some embodiments, the pitch axis and the roll axis are orthogonal horizontal axes.
(A10) In some embodiments of any of A1-A9, the set of sensors are mounted to an exterior of the sealed housing. In some embodiments, the set of sensors are mounted to opposite sides of the sealed housing. In some embodiments, the set of sensors are mounted adjacent to respective drive wheels. In some embodiments, the set of sensors are mounted above respective drive wheels. In some embodiments, one or more sensors are positioned within the sealed housing. In some embodiments, a first subset of the sensors are positioned on an exterior of the sealed housing, and a second subset of the sensors are positioned in an interior of the sealed housing. In some embodiments, the set of sensors comprises laser-based sensors. In some embodiments, the set of sensors comprises LiDAR sensors. In some embodiments, the set of sensors comprises imaging sensors. In some embodiments, the set of sensors comprises laser scanners. In some embodiments, the set of sensors are configured to provide 360-degree scan coverage around the AMR. In some embodiments, the set of sensors are configured to collect safety-related information. In some embodiments, the set of sensors are configured to collect navigation information. In some embodiments, the set of sensors are configured to perform dual functions of safety and navigation.
(A11) In some embodiments of any of A1-A10, the set of one or more functional components comprises one or more of: an energy storage device (e.g., energy storage device 452), control circuitry (e.g., control circuitry 456), and a drive wheel gearbox (e.g., drive wheel gearbox 460). In some embodiments, the energy storage device is configured to power the AMR. In some embodiments, the energy storage device is configured to power a drive system of the AMR. In some embodiments, the control circuitry comprises one or more controllers. In some embodiments, the control circuitry comprises one or more processors. In some embodiments, the control circuitry comprises a microprocessor. In some embodiments, the control circuitry comprises communication circuitry. In some embodiments, the drive wheel gearbox is configured to deliver power to the set of drive wheels. In some embodiments, the drive wheel gearbox comprises a lubrication-free gearbox. In some embodiments, the drive wheel gearbox uses food-grade gear lubricants. In some embodiments, the drive wheel gearbox uses medical-grade gear lubricants. In some embodiments, the set of one or more functional components comprises communication circuitry. In some embodiments, the set of one or more functional components comprises drive wheel control circuitry.
(A12) In some embodiments of A11, the control circuitry is configured to process sensor data from the set of sensors and adjust operation of the AMR accordingly. In some embodiments, the control circuitry is configured to trigger an alert when an object is detected in the vicinity of the AMR. In some embodiments, the object comprises a person. In some embodiments, the object comprises machinery. In some embodiments, the object comprises an obstacle. In some embodiments, the control circuitry is configured to adjust a speed of the AMR based on the sensor data. In some embodiments, the control circuitry is configured to adjust a direction of the AMR based on the sensor data. In some embodiments, the control circuitry is configured to stop the AMR based on the sensor data.
(A13) In some embodiments of any of A1-A12, the set of functional components comprises (i) a battery (e.g., battery 454); and (ii) a charger (e.g., charger 106) that is configured to charge the battery. In some embodiments, the charger comprises a battery charger. In some embodiments, the charger is configured to wirelessly charge the battery. In some embodiments, the charger is configured to charge the battery using electromagnetic induction. In some embodiments, the charger is configured for contactless charging. In some embodiments, the battery is configured to power the AMR. In some embodiments, the battery is configured to power a topper component mounted on the topper cart.
(A14) In some embodiments of A13, the charger comprises a wireless charger. In some embodiments, the wireless charger is configured to charge the battery using electromagnetic induction. In some embodiments, the wireless charger is configured for contactless charging. In some embodiments, the wireless charger is adapted to be cleanable by hand. In some embodiments, the wireless charger is adapted to be cleanable using a vaporized hydrogen peroxide process.
(A15) In some embodiments of A14, the sealed housing comprises a recess (e.g., recess 108) at a bottom of the AMR, the recess is shaped to allow an inductive charging component to be positioned within, and the wireless charger is positioned adjacent to the recess. In some embodiments, the recess is of sufficient size to allow the wireless charger to be charged via the inductive charging component. In some embodiments, the recess is of sufficient size to allow for hand cleaning of the sealed housing surfaces. In some embodiments, the sealed housing is positioned so as to allow for hand cleaning of a bottom surface without requiring a user to tip or turn over the AMR. In some embodiments, the inductive charging component is elevated off a floor surface. In some embodiments, the AMR is configured to drive over the inductive charging component. In some embodiments, the recess is flush with a bottom surface of the sealed housing. In some embodiments, the recess is up to 100 mm above the bottom surface of the sealed housing. In some embodiments the recess is elevated to allow for hand cleaning of the recess without dismantling or tipping the AMR. In some embodiments, the recess has a width/length in the range of 50 to 300 mm.
(A16) In some embodiments of A15, the wireless charger is configured to receive power signals from an inductive charging device on a surface while the inductive charging device is positioned in the recess at the bottom of the housing. In some embodiments, the inductive charging device is positioned below the recess. In some embodiments, the AMR is configured to park above the inductive charging device during charging. In some embodiments, the inductive charging device is elevated off a floor surface.
(A17) In some embodiments of A15 or A16, a portion of the sealed housing defining the recess is composed of a dielectric material. In some embodiments, the dielectric material comprises silicone. In some embodiments, the dielectric material comprises plastic. In some embodiments, the portion of the sealed housing defining the recess is composed of a material other than steel. In some embodiments, other portions of the sealed housing are composed of stainless steel. In some embodiments, the dielectric material has a thickness in the range of 2 mm to 5 mm. For example, the dielectric material may comprise 3 mm thick plexiglass. In some embodiments, the dielectric material has dimensions that exceed the dimensions of the recess (e.g., by 10 mm, 50 mm, or other amount).
(A18) In some embodiments of any of A1-A17, the AMR includes an electrical cable that penetrates the sealed housing and is configured to electrically couple the set of functional components with a topper component mounted on the topper cart. In some embodiments, the electrical cable is configured to provide power from the set of functional components to the topper component. In some embodiments, the electrical cable is configured to provide control signals from the set of functional components to the topper component. In some embodiments, the electrical cable includes a sheathing that complies with one or more cleanroom standards. In some embodiments, the electrical cable includes a connector that complies with one or more cleanroom standards. In some embodiments, the electrical cable comprises a flexible electrical cable. In some embodiments, the one or more cleanroom standards comprises Good Manufacturing Practice standards.
(A19) In some embodiments of any of A1-A18, the AMR is an autonomous guided vehicle. In some embodiments, the AMR comprises a tugger. In some embodiments, the AMR comprises a power lift. In some embodiments, the AMR comprises an autonomous forklift.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “and/or” encompasses any combination of listed elements. For example, “A, B, and/or C” entails each of the following possibilities: A only, B only, C only, A and B without C, A and C without B, B and C without A, and a combination of A, B, and C. Additionally, although the terms “first,” “second,” etc., may be used herein to describe various elements, these elements should not be limited by these terms. These terms are only used to distinguish one element from another.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrases “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. An autonomous mobile robot (AMR), comprising:
a set of one or more functional components enclosed in a sealed housing;
a set of sensors configured to monitor a vicinity of the AMR;
a compliant linkage configured to connect the sealed housing to a topper cart with relative movement between the sealed housing and the topper cart in two degrees of freedom; and
a set of drive wheels coupled to the sealed housing and configured to enable movement of the AMR.

2. The AMR of claim 1, wherein the sealed housing is configured such that surfaces of the sealed housing are accessible for hand cleaning without dismantling the AMR.

3. The AMR of claim 1, further comprising the topper cart, wherein the topper cart comprises:
a frame configured to support a topper component; and
a plurality of non-drive wheels positioned at a base of the frame.

4. The AMR of claim 3, wherein each wheel of the plurality of non-drive wheels is positioned at a respective corner of the topper cart.

5. The AMR of claim 3, wherein the topper cart further comprises a toe guard configured to prevent the set of drive wheels from rolling over a person's foot.

6. The AMR of claim 3, wherein the frame includes up to one support for each side of the AMR.

7. The AMR of claim 1, wherein the compliant linkage comprises a rotary joint.

8. The AMR of claim 1, wherein the compliant linkage is composed of a stainless steel material.

9. The AMR of claim 1, wherein the compliant linkage is configured to allow the set of one or more functional components enclosed in the sealed housing to move about a pitch axis and a roll axis with respect to the topper cart.

10. The AMR of claim 1, wherein the set of sensors are mounted to an exterior of the sealed housing.

11. The AMR of claim 1, wherein the set of one or more functional components comprises one or more of: an energy storage device, control circuitry, and a drive wheel gearbox.

12. The AMR of claim 1, wherein the control circuitry is configured to process sensor data from the set of sensors and adjust operation of the AMR accordingly.

13. The AMR of claim 1, wherein the set of functional components comprises: a battery; and
a charger that is configured to charge the battery.

14. The AMR of claim 13, wherein the charger comprises a wireless charger.

15. The AMR of claim 14, wherein the sealed housing comprises a recess at a bottom of the AMR, the recess is shaped to allow an inductive charging component to be positioned within, and wherein the wireless charger is positioned adjacent to the recess.

16. The AMR of claim 15, wherein the wireless charger is configured to receive power signals from an inductive charging device on a surface while the inductive charging device is positioned in the recess at the bottom of the housing.

17. The AMR of claim 15, wherein a portion of the sealed housing defining the recess is composed of a dielectric material.

18. The AMR of claim 1, wherein the AMR includes an electrical cable that penetrates the sealed housing and is configured to electrically couple the set of functional components with a topper component mounted on the topper cart.

19. The AMR of claim 1, wherein the AMR is an autonomous guided vehicle.
